(19) United States
(12) Patent Application Publication
(10) Pub. No.: US 2016/0232741 A1
(43) Pub. Date: Aug. 11, 2016

(54) Lottery Ticket Vending Device, System and Method

(71) Applicant: IGT Global Solutions Corporation, Providence, RI (US)

(72) Inventors: Marcelo Assis, Providence, RI (US); Wayne DePhil, Providence, RI (US); Sivananaintha Duraiswamy, Warwick, RI (US); Mikhail Gerdov, Moncton (CA); Erik Hanley, Coventry, RI (US); Rabia Karatela, Park City, UT (US); Christian Maxwell, Framingham, MA (US); Robert S. Melesko, Richmond, RI (US); Rachel Duprey Miller, Providence, RI (US); Cameron W. Moody, West Warwick, RI (US); Bruce Parkes, Providence, RI (US)

(21) Appl. No.: 15/016,398

(22) Filed: Feb. 5, 2016

Related U.S. Application Data
(60) Provisional application No. 62/112,466, filed on Feb. 5, 2015.

(51) Int. Cl. G07F 17/32

(52) U.S. Cl. CPC G07F 17/329; G07F 17/3253

(57) ABSTRACT

A system, method and device incorporate a touch-screen communications interface configured to receive input and display output, including presenting on the communications interface a plurality of ticket purchase options in a first arrangement and at least a position adjustment selection option. Upon receipt of a selection of the position adjustment selection option, the ticket purchase options are re-presented in a second arrangement that is different from the first arrangement for the benefit of a variety of user types. A central controller is in operable communication with one or more vending devices to manage display specifications and process various game and other requests received at the one or more vending devices.

### FIELD OF THE INVENTION

The present invention pertains to lottery ticket vending machines, and more particularly to a device, system and method for providing specially adapted touch screen interfaces for lottery ticket vending machines.

### BACKGROUND

Lottery retailers work with lottery operators to distribute tickets and collect payments, and lottery retailers often earn payments from lottery operators based on selling winning tickets as well as overall sales. Further, unattended lottery vending machines (LVMs) have become more pervasive as an alternative vending option to clerk-attended retail locations for various lottery products.

Touch screen interfaces on LVMs are known. However, the positioning of icons on the visual display of an LVM's touch screen interface is generally static or only changed by a controller of the vending machine. The icon positioning is not manipulable by a user or purchaser of the lottery product offered by the vending machine. As a result, different types of tickets appear at eye-level for different types of people depending upon each person's height and/or physical capabilities.

### SUMMARY

Aspects of the present invention provide a touch screen vending device for lottery tickets. In various embodiments of the present invention, instant tickets and tickets for draw-based games are shown on a display of a touch screen interface of a vending device. A user inserts a form of payment into the vending machine and selects one or more ticket icons by touching the screen where the desired icon resides. The machine processes the order and dispenses the selected ticket(s) into a bin at the bottom of the machine.

In addition to touching the screen associated with a ticket position, several functional icons can be selected in accordance with aspects of the present invention, including “Help”, “Language” and “Flip Screen” icons. Touching the Flip Screen icon causes the system of the present invention to visually re-arrange the tickets. For example, the tickets initially appearing at the top of the screen can be brought to the bottom portion of the screen, and vice versa. In this way, a person who may be unable to reach the top of the screen can bring any desired ticket icons from the top down to the bottom of the screen for selection. Alternatively, a very tall person who may not wish to stoop to read tickets at the bottom of the screen can bring ticket icons from the bottom of the screen to the top for selection. The positioning of the “Flip Screen” and other functional icons can be at the bottom, in the middle, or elsewhere in a similarly easily accessible location on the display screen.

Accordingly, various embodiments of the present invention provide a system, method and vending device incorporating a touch-screen communications interface configured to receive input and display output, a memory, and at least one processor configured to present, on the communications interface, a plurality of ticket purchase options in a first arrangement, with each ticket purchase option being associated with an independent ticket game. The processor is further configured to present, on the communications interface, a position adjustment selection option and receive, via the communications interface, a selection from a user of the position adjustment selection option. According to various embodiments, in response to the received selection, the processor can re-present the ticket purchase options in a second arrangement that is different from the first arrangement. In various embodiments, a portion of the ticket options are for instant wagering games and a portion of the ticket options are for draw-based wagering games. Further, the first arrangement can include at least two ticket purchase options in a first configuration, and at least two ticket purchase options in a second configuration, with the first configuration being presented above the second configuration on the display, and wherein the second arrangement includes the second configuration presented above the first configuration on the display.

Various other image and design elements can be incorporated with the interface for the vending device, system and method according to embodiments of the present invention, including displaying a “New” symbol on the interface display to denote new games, or a “Quantity Left” symbol on the interface display to denote the number of tickets left. The present invention can also display a game animation on the interface, a touch-screen area to select a predetermined number of tickets (e.g., 1, 2, 3, 4 or 5 tickets), ticket numbers or a predetermined purchase price (e.g., $2 or $4 ticket), a ticket animation showing the selected ticket “falling” to the bottom of the screen, while the interior components of the vending machine dispense an actual ticket into the receiving bucket of the machine, and a messaging area which provides a visual indication of a machine issue such as paper low, door open, no inventory, or other messaging, through color coding or other coding, for example.

### BRIEF DESCRIPTION OF THE DRAWINGS

FIG. 1 is a sample schematic diagram illustrating components associated with embodiments of the present invention.

FIG. 2 shows a sample vending device in accordance with embodiments of the present invention.

FIGS. 3 through 11 are exemplary communications interface displays in accordance with aspects of the present invention.

### DETAILED DESCRIPTION OF INVENTIVE ASPECTS

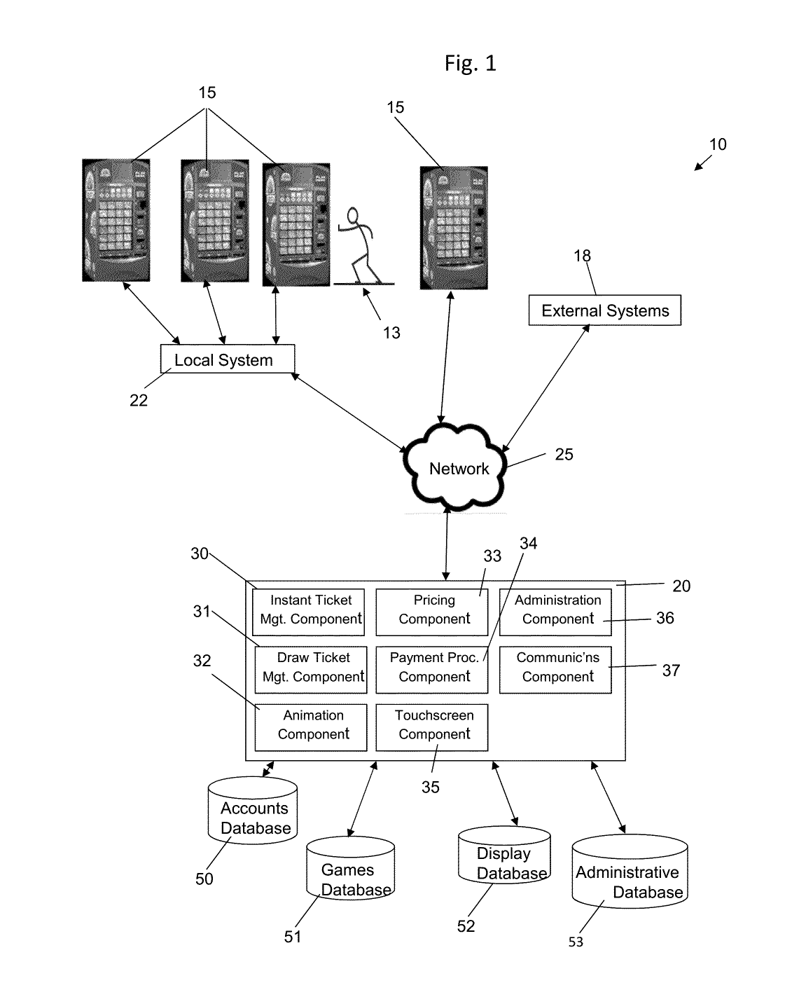

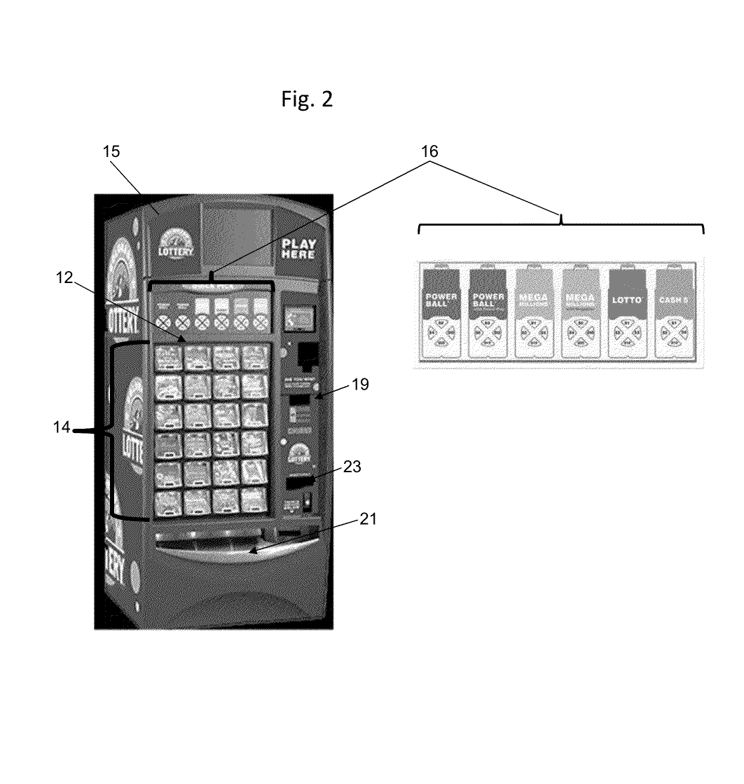

With reference to the system 10 in the embodiment of the present invention shown in FIGS. 1 and 2, and depending upon the implementation, a wager request from a purchaser (“purchaser” may also be called a “player”, “user” or “wagerer” herein) 13 may be received at a lottery vending machine (LVM) device 15. The wager request can be processed locally by the LVM device 15, and details about the transaction can then be transferred to the central system and/or central controller 20. For instance, a purchaser 13 may purchase an available instant ticket by pressing an icon on the interface 12 of the device 15 associated with the desired ticket, and the LVM device 15 can then process the input to burst a ticket corresponding to the selected game from within the LVM device 15, such that the ticket falls to a dispenser tray (21 in FIG. 2) for retrieval by the purchaser. Details about the purchase can be communicated to central controller 20 via network 25, for example. Alternatively, the wager request can be transferred to the central controller 20 in order to be processed, and then appropriate wager communications can be sent back to the LVM device 15 in order to issue a ticket to the purchaser 13 according to the wager made. For instance, if the purchaser 13 desires to purchase a lottery ticket for a draw-based game using a “quick pick” feature, the numbers for the purchaser's wager can be randomly determined by the central controller 20, returned to the LVM device 15, and printed on a ticket. Details about the purchased ticket, such as the player numbers selected and printed on the ticket, the LVM device from which the ticket was purchased, and other details can be stored via the central controller 20. Various types of lottery tickets can be purchased at the LVM devices 15, including instant, scratch-off tickets as well as tickets for draw-based games.

In various embodiments, as shown in FIG. 1, the present invention can operate with one or more LVM devices 15 in networked connection with a centralized management computer system and/or controller 20. The centralized computer system and/or controller 20 can provide instructions to the one or more vending units 15 as the vending units 15 carry out their designed functions. It will be appreciated that system 10 can be deployed with direct connections from central controller 20 to a device 15 via network 25, or indirect connection through a local computing system 22. Processing of the actual transaction request can occur at the central controller 20 or another controller associated with transaction and wager processing for the selected ticket, including any loyalty and related player account details, for example, and such processing will not be described in substantial detail herein. At a minimum, though, controller 20 processes data about the transaction for use in LVM-level analysis, and such data can be obtained, reviewed, manipulated and managed via administrative component 36, for example.

The centralized computer system and/or controller 20 can be provided with various components or aspects, such as an instant ticket game management component 30, a draw-based ticket game management component 31, an animation component 32, a pricing component 33, a payment processing component 34, a touch-screen function component 35, an administrative component 36, a communications component 37 and other components. Such components can comprise, for example, software programming stored in memory in one or more databases to be executed by one or more processors to carry out the processes and functions described herein.

These components can access and employ various databases for storing and retrieving data in accordance with the desired functions of the present invention. Databases can include, for example, an accounts database 50, a game database 51, a display database 52 and an administrative database 53. The accounts database 50 can store information related to player accounts, including player identification details, player usage and transaction history, player preferences, player financial information and account details and other information. The game database 51 can store information pertaining to available games for selection and deployment, including graphic designs, indicia, scratch-off locations, available wager amounts, odds and other game-related elements. The display database 52 can store a library of displays to be presented on the vending device interfaces 15, including player selection options (e.g., for touch-screen selection) as well as visual outcome displays or animations employed during inactive periods or for entertainment during player use. The display database 52 can also store configuration options, and other elements. Administrative database 53 can store information such as device-specific statistics to permit lottery service providers (LSPs), lottery operators and retailers to better understand device usage, including game-related statistics, ticket volumes, retailer statistics and other information that can assist in better servicing players, increasing revenue and overall management of devices, for example.

Administrative component 36 can be used to configure LVM device settings for deployment, ticket game offerings, inventory management and other back-end functions. The administrative component 36 further processes administrative related information, such as statistics and administrative control information, to and from administrative database 53. Such information can be employed by external systems 18 such as an external administrative operator, or by local systems, such as system 22, which can be a retailer operation controlling multiple devices 15 as shown in FIG. 1, for example.

Communications component 37 can be employed to manage communications between the central controller 20 and LVM devices over network 25 and any local computing systems 22, which can include local area networks (LANs), for example. Touch-screen function component 35 can be employed to configure what functions, such as “Help”, “Language” and “Flip Screen” are offered on the interface 12 of each LVM 15.

Instant ticket game management component 30 can be used (optionally with administrative component 36) to manage which instant ticket games and icons are available on the LVM devices, as well as to manage inventory levels and popularity in order to inform relevant business analysis. The draw-based ticket game management component 31 can be used (optionally with administrative component 36) similarly to the instant ticket game management component 30, but with regard to draw-based games instead of instant games. Ticket icons can be presented by the central controller 20 to one or more LVM devices 15 in the form of specifications from database 52. Once received, the LVM device 15 can execute programming to reveal the specified ticket icons on the display 12. It will be appreciated that ticket icons for display on the communications interface are employed to match the physical tickets that have been received and stored within the LVM device for dispensing when selected by a purchaser. In various embodiments, once physical tickets are identified to the LVM device as the tickets being inserted in ticket dispensing bins of the LVM device, corresponding ticket icons are identified and subsequently presented on the display 12 as being available for purchase through the LVM device 15.

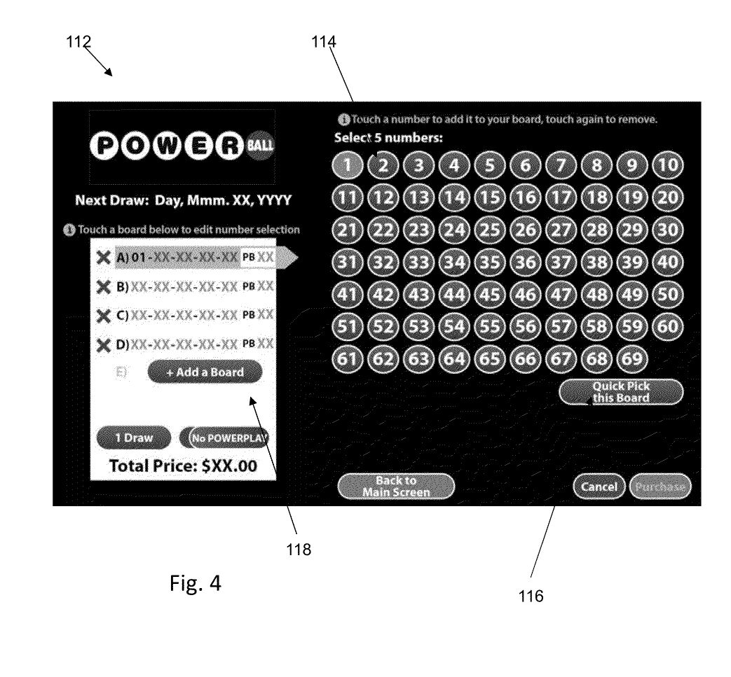

Animation component 32 can be used to manage different types of animations and visual displays to be employed on the LVM device interfaces 12. In various embodiments of the present invention, instant tickets can be shown on the user interface with a vending animation, where virtual tickets are shown as dropping toward the bucket from their position in the GUI grid. Online, or draw-based, tickets can have a print and vending animation where they drop toward the bucket from the online ticket quick pick selection interface, such as that shown at 116 in FIG. 4, for example.

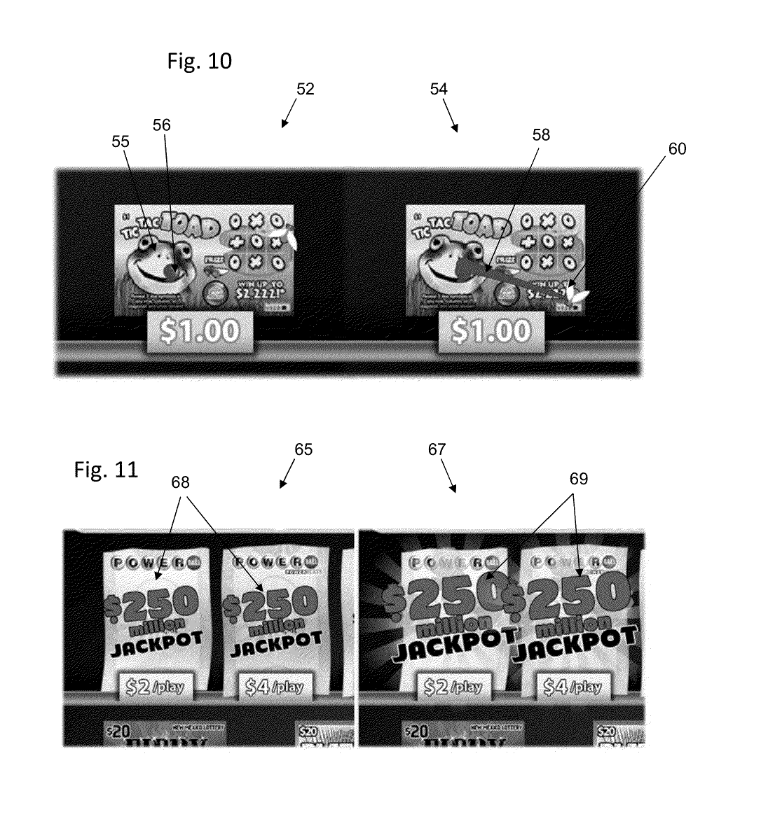

In various embodiments, in-ticket animations can be provided as well. In such embodiments, small animations can be shown on a per ticket button, as illustrated in FIGS. 10 and 11. As shown in FIG. 10, the snapshots 52, 54 of the animated instant ticket display show a frog 55 initially with a small tongue 56, and subsequently with a tongue reaching out as at 58 to catch a fly 60. As shown in FIG. 11, the snapshots 65, 67 of the animated draw-based ticket display show a jackpot amount in smaller size at 68, then in larger size at 69. Animations can be presented by the central controller 20 to one or more LVM devices 15 in the form of specifications from database 52. Once received, the LVM device 15 can execute programming to reveal the specified animation on the display 12.

Pricing component 33 can be used to manage the ticket prices for various ticket games offered on the LVM devices. Payment processing component 34 can be used to process and account for financial transactions associated with the LVM devices, including credit, debit, cashless, ticket-based, loyalty reward/redemption, cash and other forms of payment, for example.

In various embodiments, the LVM devices 15 include at least one processor, memory and software programming stored in memory and executable by the at least processor to conduct various operations required by the LVM devices. For instance, the LVM devices 15 include programming to process codes associated with unpurchased tickets being loaded into physical bins within the device. The LVM devices 15 further include programming to process financial transactions for purchasers 13 of tickets, process received inputs, display appropriate visual and auditory displays, and operate ticket processing functions, such as bursting and tearing tickets from ticket rolls within the LVM devices. The LVM devices 15 can further include programming to display appropriate icons, informational content and entertaining animations in order to provide a functional and visually appealing interface 12 for purchasers 13. Depending upon embodiments being employed, the LVM devices 15 may operate according to locally stored instructions, or may operate based upon instructions received from the central system 20.

The LVM device touch-screen communications interface 12 can be configured, for example, to receive input and display output on the communications interface. In various embodiments, as shown in FIGS. 2 through 4, for example, the interface 12 can display instant ticket game selection options 14 and draw-based ticket game selection options 16. For draw-based games, the display can receive input from a purchaser indicating that the purchaser wants to select his or her own numbers, and can further receive input from a purchaser indicating that the purchaser would like the numbers randomly selected, such as by central controller 20. In the event the purchaser wishes to purchase a ticket for a draw-based game, the purchaser may first select one of the ticket options from the draw-based game menu (see 16 in FIG. 2), and then the player may either select his or her own numbers, enter a ticket playslip through a slot (such as slot 23 in FIG. 2) or may select a quick-pick option. For example, as shown in the interface 112 of FIG. 4, the purchaser can select numbers directly from a first portion 114 of the interface 112, or may alternatively select a quick-pick option from a second portion 116 of the interface 112. Further, the purchaser can make multiple wagers and selections that can be displayed at the same time on a third portion 118 of the interface 112. As shown in FIG. 2, the LVM device 15 can include a bill collector 19 and a ticket dispenser tray 21.

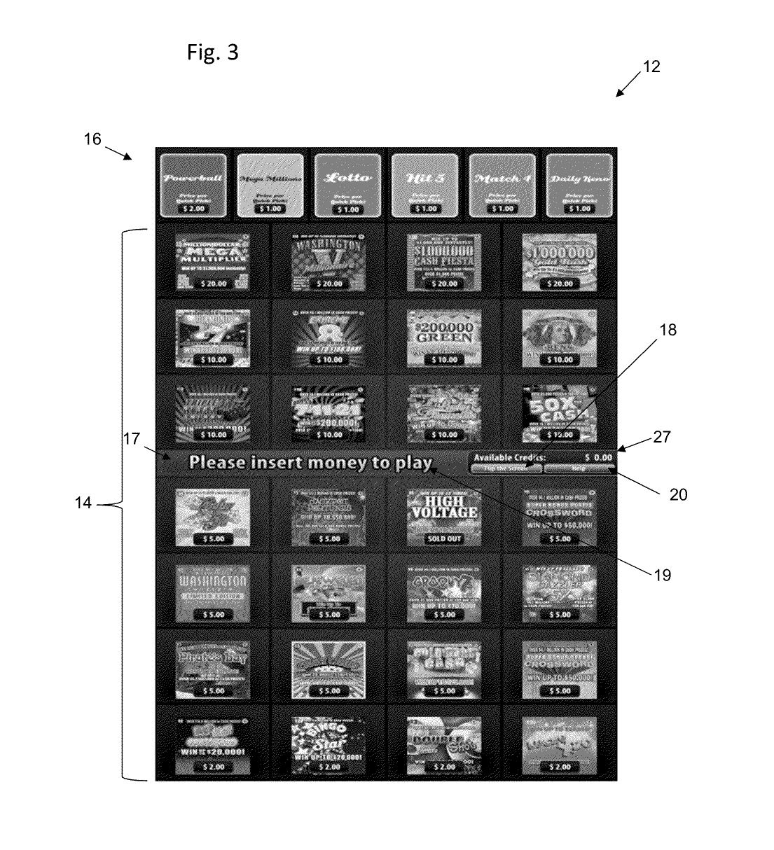

As shown in display 12 of FIG. 3, a banner 17 is provided that houses the terminal prompts/call-to-actions/messaging area 19, the terminal credits 27, and functional buttons (e.g., 18, 20). The functional buttons can include functions such as LANGUAGE (to change the language), HELP 20, and FLIP SCREEN 18, as described elsewhere herein. These buttons can be positioned just below the physical center of the screen, vertically, but can be re-positioned elsewhere, in various embodiments of the present invention.

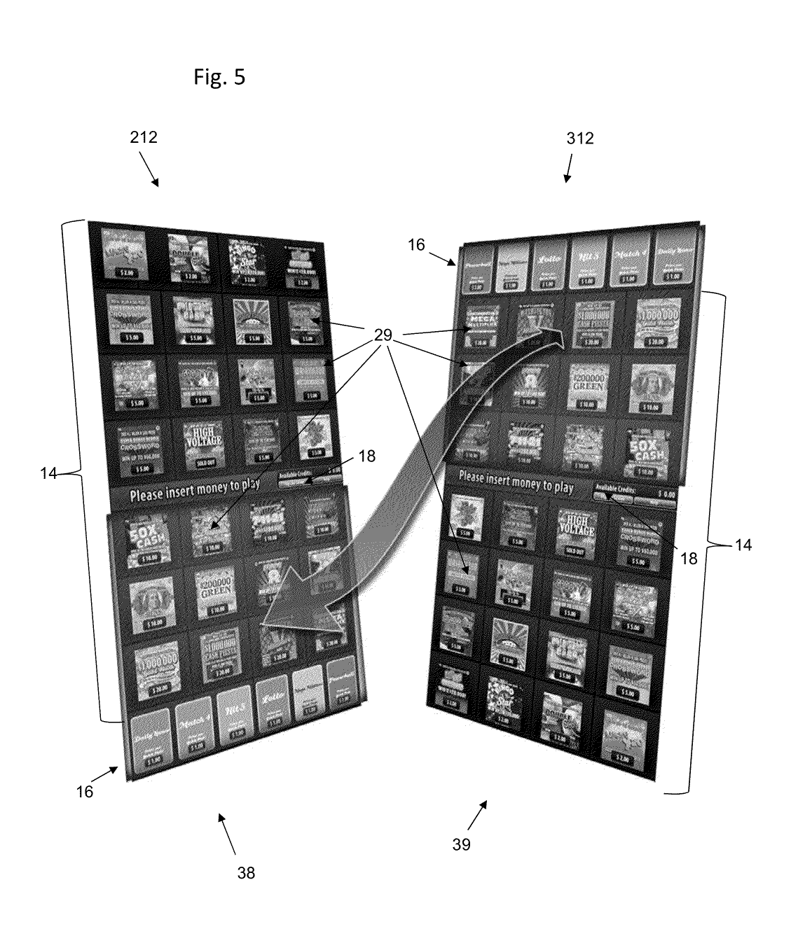

As shown in FIG. 5, a plurality of ticket purchase options 29 can be presented in a first arrangement 38, such as draw-based ticket purchase options 16 being positioned below instant ticket purchase options 14 in interface 212, with each ticket purchase option 29 being associated with an independent ticket game. The processor is further configured to present, on the communications interface 212, a position adjustment selection option such as “Flip the Screen” icon 18 and receive, via the communications interface 212, a selection from a user of the position adjustment selection option 18. According to various embodiments, in response to receiving the “Flip Screen” or other position adjustment selection option, the processor can re-present the ticket purchase options in a second arrangement 39 on interface 312, wherein the second arrangement is different from the first arrangement 38. In various embodiments, as shown in FIG. 5, a portion 14 of the ticket options are for instant wagering games and a portion 16 of the ticket options are for draw-based wagering games. Further, the first arrangement 38 can include at least two ticket purchase options in a first configuration, and at least two ticket purchase options in a second configuration, with the first configuration being presented above the second configuration on the display. Such is the case with instant ticket options 14 being presented above the draw-based game selection options 16 in interface 212 of FIG. 5. In the interface 312 showing the second arrangement 39, the second configuration (e.g., draw-based game selection options 16) is presented above the first configuration (e.g., instant ticket selection options 14) on the display 312.

In addition to receiving a player request to re-configure positioning of ticket selection options on the interface, the LVM can receive a wager request from a player, including the selection of a desired game, ticket design, number of tickets, wager level, prize structure or other selection. Such selections can be made through touching one or more user inputs on interface 12. Once the payment and ticket selection have been received by the device 15, an internal communications component on the LVM can send the information to central controller 20 via network 25, whereupon the communications component 35 of the central controller 20 receives the specific inputs and game data that have been transferred. The data can be collected and automatically populated into administrative user displays, or alternatively, the data can be entered manually into one or more computer systems operating programming according to the present invention.

The specific software components described herein can comprise computer-readable instructions stored in suitable memory and operable by one or more processors to perform the functions necessary for operation of the embodiments of the present invention. For instance, the instant ticket 30 and draw ticket 31 management components can operate to deliver instructions to the vending devices 15 for operation, including, for example, what instant and draw ticket icons to display on the graphical user interface, and the touchscreen component can operate to deliver instructions to the devices 15 as to what format to use in the display.

The communications component 35 operates to communicate with the vending devices 15 and external providers 18 over network 25 to perform functions in accordance with the embodiments of the present invention. For example, if a user desires to publish information associated with the operation of the present invention to a lottery operator website, the communications component 35 can operate to send the information to a suitable external system 18 for appropriate action.

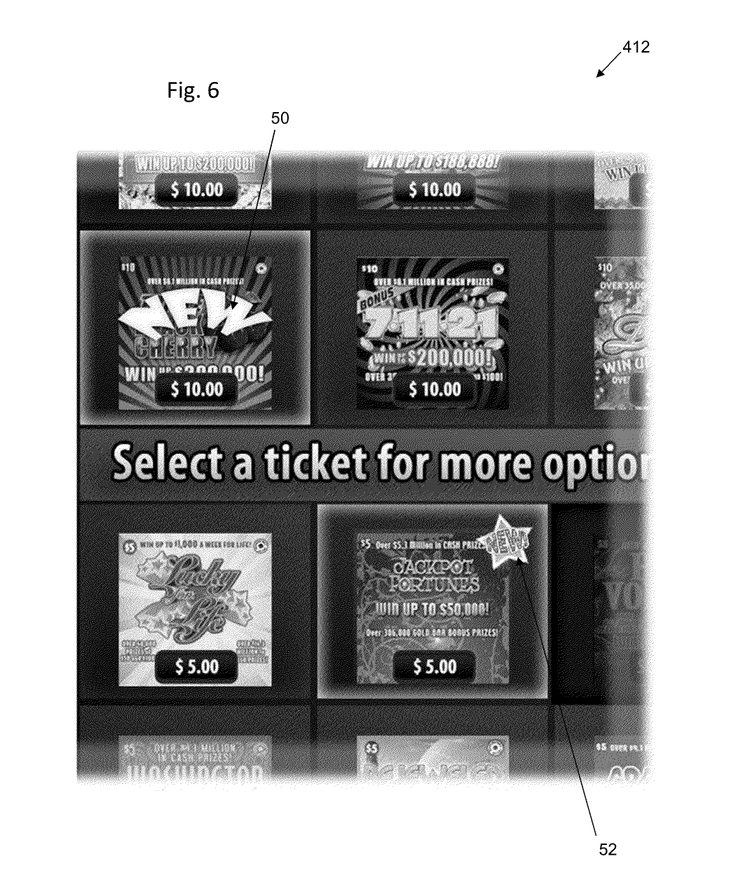

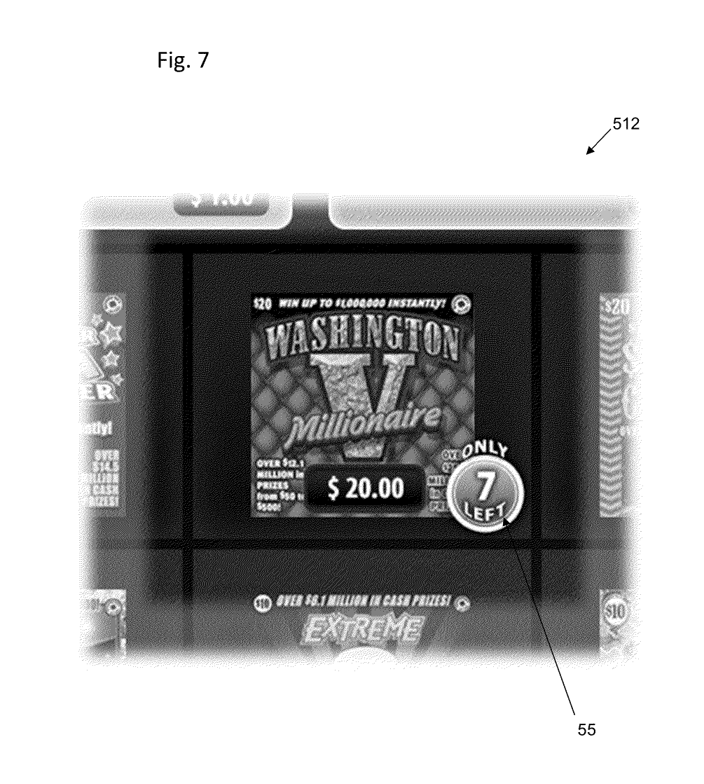

In various embodiments, new tickets made available for purchase can be marked with a “NEW” graphic call out, as illustrated at 50 and 52 in interface 412 of FIG. 6, for example. Further, instant tickets can be marked with an indication of the quantity of tickets left once the storage bin falls below a configurable threshold, as illustrated at 55 in interface 512 of FIG. 7, for example.

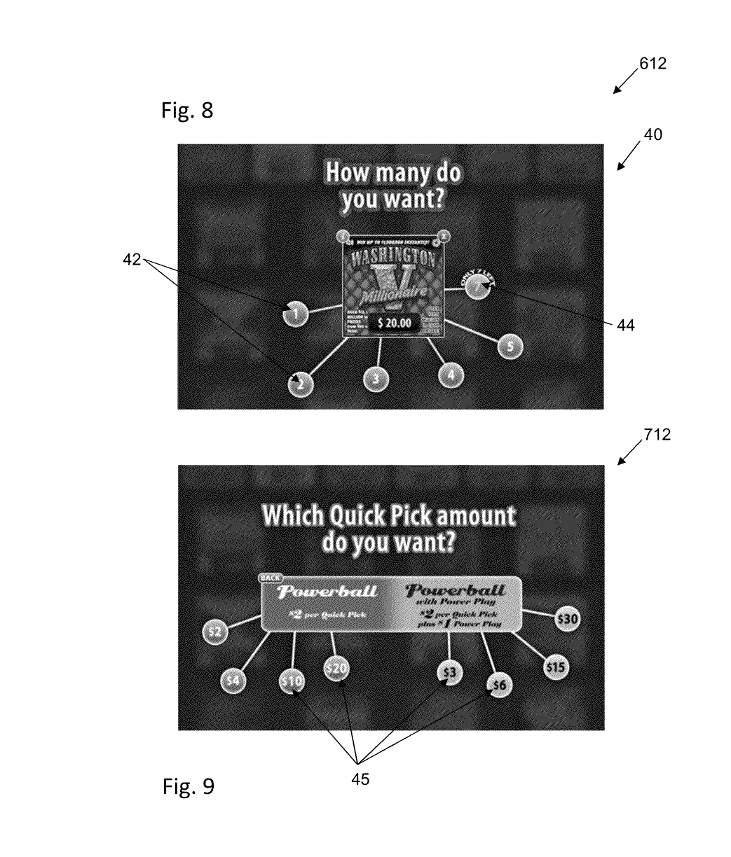

In various embodiments of the present invention, secondary screens, as exemplified in FIGS. 8 and 9, can show ticket and purchase options. For example, screen 612 in FIG. 8 can show purchase options for instant tickets as pre-selected quantities of tickets (e.g., 1, 2, 3, 4, 5) as indicated at 42, as well as the number of tickets remaining, as indicated at 44. Purchase options for online tickets can be represented as pre-selected price points as indicated at 45 of interface 712 in FIG. 9, for example, including with special options included. It will be appreciated that default prices can depend on the game. For example, with a POWERBALL game, quick picks can be priced at $2, $4, $10 and $20.

In various embodiments, the present invention can operate with one or more vending units in networked connection with a centralized management computer system, as shown in FIG. 1 and described elsewhere herein. The centralized computer system can provide instructions to the one or more vending units as the vending units carry out their designed functions. The centralized computer system can be provided with various components or aspects, such as an instant ticket game management component, a draw-based ticket game management component, an animation component, a pricing component, a payment processing component, a touch-screen function component and other components. Such components can comprise, for example, software programming stored in one or more databases to be executed by one or more processors to carry out the processes and functions described above.

It will be appreciated that all of the disclosed methods and procedures herein can be implemented using one or more computer programs or components. These components may be provided as a series of computer instructions on any conventional computer-readable medium, including RAM, SATA DOM or other storage media. The instructions may be configured to be executed by a processor which, when executing the series of computer instructions, performs or facilitates the performance of all or part of the disclosed methods and procedures.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media. At a minimum, the memory includes at least one set of instructions that is either permanently or temporarily stored. The processor executes the instructions that are stored in order to process data. The set of instructions can include various instructions that perform a particular task or tasks. Such a set of instructions for performing a particular task can be characterized as a program, software program, software, engine, module, component, mechanism, or tool. Common forms of computer-readable media that may be used in the performance of the present invention include, but are not limited to, RAM, USB drive or any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, USB and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions associated with the present invention to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO. Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art. Appropriate encryption and other security methodologies can also be employed by the system of the present invention, as will be understood to one of ordinary skill in the art.

The invention may be embodied in other specific forms without departing from the spirit or essential characteristics thereof. The present embodiments are therefore to be considered in all respects as illustrative and not restrictive, the scope of the invention being indicated by the claims of the application rather than by the foregoing description, and all changes which come within the meaning and range of equivalency of the claims are therefore intended to be embraced therein.

1. A ticket vending device, comprising:
a touch-screen communications interface configured to receive input and display output;
a memory; and
at least one processor configured to:
present, on the communications interface, a plurality of ticket purchase options in a first arrangement, with each ticket purchase option being associated with an independent ticket game;
present, on the communications interface, a position adjustment selection option;
receive, via the communications interface, a selection from a user of the position adjustment selection option; and
in response to the received selection, re-presenting the plurality of ticket purchase options in a second arrangement that is different from the first arrangement.

2. The device of claim 1, wherein a portion of the ticket options are for instant wagering games and a portion of the ticket options are for draw-based wagering games.

3. The device of claim 1, wherein the first arrangement includes at least two ticket purchase options in a first configuration, and at least two ticket purchase options in a second configuration, with the first configuration being presented above the second configuration on the display, and further wherein the second arrangement includes the second configuration presented above the first configuration on the display.

4. The device of claim 1, wherein the at least one processor is configured to present, on the communications interface, a symbol on the interface display to denote new ticket purchase options.

5. The device of claim 1, wherein the at least one processor is configured to present, on the communications interface, a symbol on the interface display to denote the quantity of independent ticket games available in the device for at least one of the ticket purchase options.

6. The device of claim 1, wherein the at least one processor is configured to present, on the communications interface, a ticket animation associated with at least one of the ticket purchase options.

7. The device of claim 1, wherein the at least one processor is configured to receive, via the communications interface, a selection from a user of a ticket selection option after receiving the selection of the position adjustment selection option.

8. The device of claim 7, wherein the at least one processor is configured to dispense a ticket corresponding to the selection of the ticket selection option.

9. A gaming system, comprising:
at least one gaming device having a touch-screen communications interface configured to receive input and display output, wherein the output includes a plurality of ticket purchase options in a first arrangement and a position adjustment selection option, wherein the receipt of input in the form of a selection of the position adjustment selection option results in the plurality of ticket purchase options being re-presented in a second arrangement that is different from the first arrangement; and
a controller configured to operate with the touch-screen communications interface to:
receive a ticket purchase option selection from the communications interface; and
process the ticket purchase option and communicate ticket purchase details to the at least one gaming device.

10. The gaming system of claim 9, wherein the controller is configured to communicate ticket game selection option icons to the at least one gaming device.

11. The gaming system of claim 9, wherein the controller is configured to communicate animation specifications to the at least one gaming device.

12. A method for operating a ticket vending device, comprising:
providing a touch-screen communications interface configured to receive input and display output;
providing a memory; and
causing at least one processor to:
present, on the communications interface, a plurality of ticket purchase options in a first arrangement, with each ticket purchase option being associated with an independent ticket game;
present, on the communications interface, a position adjustment selection option;
receive, via the communications interface, a selection from a user of the position adjustment selection option; and
in response to the received selection, re-presenting the plurality of ticket purchase options in a second arrangement that is different from the first arrangement.

13. The method of claim 12, wherein a portion of the ticket options are for instant wagering games and a portion of the ticket options are for draw-based wagering games.

14. The method of claim 12, wherein the first arrangement includes at least two ticket purchase options in a first configuration, and at least two ticket purchase options in a second configuration, with the first configuration being presented above the second configuration on the display, and further wherein the second arrangement includes the second configuration presented above the first configuration on the display.

15. The method of claim 12, further including the step of causing the at least one processor to present, on the communications interface, a symbol on the interface display to denote new ticket purchase options.

16. The method of claim 12, further including the step of causing the at least one processor to present, on the communications interface, a symbol on the interface display to denote the quantity of independent ticket games available in the device for at least one of the ticket purchase options.

17. The method of claim 12, further including the step of causing the at least one processor to present, on the communications interface, a ticket animation associated with at least one of the ticket purchase options.

18. The method of claim 12, further including the step of causing wherein the at least one processor is configured to receive, via the communications interface, a selection from a user of a ticket selection option after receiving the selection of the position adjustment selection option.

19. The device of claim 7, wherein the at least one processor is configured to dispense a ticket corresponding to the selection of the ticket selection option.
